(19) United States
(12) Patent Application Publication
(10) Pub. No.: US 2024/0066714 A1
(43) Pub. Date: Feb. 29, 2024

(54) ASSEMBLY AND APPARATUS FOR MACHINING MECHANICAL PART

(71) Applicant: ABB Schweiz AG, Baden (CH)

(72) Inventors: Yong Chen, Shanghai (CN); Yiyuan Zhu, Shanghai (CN); Fan Bai, Shanghai (CN)

(21) Appl. No.: 18/260,103

(22) PCT Filed: Feb. 1, 2021
(86) PCT No.: PCT/CN2021/074703

§ 371 Date: Jun. 30, 2023

(51) Int. Cl. B25J 11/00; B23B 39/14; B23C 9/00

(52) U.S. Cl. CPC B25J 11/0055; B23B 39/14; B23C 9/00

(57) ABSTRACT

An assembly and an apparatus for machining a mechanical part. The assembly includes a parallel robot configured to be mounted onto an end flange of a joint robot. The parallel robot is configured to drive the servo spindle to translate along the one or more axes with respect to the parallel robot. During the machining of the mechanical part, the joint robot can stay stationary for a specific machining position of the mechanical part, and the parallel robot drives the servo spindle to translate along the one or more axes. Then, the machining tool may cut out the required shapes and characteristics at the specific machining position of the mechanical part.

### FIELD

Example embodiments of the present disclosure generally relate to the field of mechanical part machining, and more specifically, to an assembly and an apparatus for machining a mechanical part.

### BACKGROUND

Milling is a conventional process for part machining. A traditional mode of the milling is to use a computerized numerical control (CNC) milling machine or machining center to process a mechanical part. During the milling, a blank of the mechanical part is first fixed onto the CNC milling machine or machining center. Then, a high-speed rotary milling cutter is used to cut out required shapes and characteristics on the blank.

Currently, the most general mode of the milling is to use the milling machining center. The milling machining center can achieve a high-accuracy machining, but meanwhile it brings a number of shortcomings. First, owning to a limited operating range of the milling machining center, it can only be used to process mechanical parts of small to medium size instead of those of large size, such as aluminum work pieces. Second, the mechanical parts having complex curved surfaces are not able to be easily processed unless the machining center having five axes is adopted, which, however, would result in a low processing efficiency. Third, a large scale machining center or even a gantry type machining center is often required to support the processing of the mechanical parts of larger size, which would cause the cost of the machining center to be relatively high. Fourth, as the machining center occupies a large area, it is difficult to cooperate with other automatic equipment to realize automatic production lines. Fifth, in the machining center, a dedicated and customized fixture tooling would be needed to process different mechanical parts. Thus, the flexibility of the machining center is unsatisfactory.

Another conventional mode of the milling is to use an industrial robot, such as a six-axis joint robot, to hold the milling cutter for cutting the mechanical part. However, since the six-axis joint robot includes several joints, the stiffness of the six-axis joint robot would be low if the axes of the six-axis joint robot moves or rotates during the milling. In this case, the accuracy of milling using the six-axis joint robot would be adversely affected.

Thus, there is a need for an improved solution for milling the mechanical part.

### SUMMARY

In view of the foregoing problems, example embodiments of the present disclosure propose an assembly and an apparatus for machining a mechanical part to reduce process difficulty and cost of the part machining and to increase process efficiency, flexibility and stiffness of the part machining.

In a first aspect, example embodiments of the present disclosure provide an assembly for machining a mechanical part. The assembly comprises a parallel robot adapted to be mounted onto an end flange of a joint robot and comprising one or more axes; and a servo spindle mounted on the parallel robot and configured to drive a machining tool to rotate, wherein the parallel robot is configured to drive the servo spindle to translate along the one or more axes with respect to the parallel robot. With these embodiments, during the machining of the mechanical part, the joint robot may stay stationary for a specific machining position of the mechanical part, and only the parallel robot drives the servo spindle to translate along the one or more axes. Then, the machining tool may cut out the required shapes and characteristics at the specific machining position of the mechanical part. In this way, the mechanical part may be processed with high flexibility and stiffness in the case that the machining accuracy meets the requirements.

In some embodiments, the parallel robot is a single-axis robot configured to drive the servo spindle to translate along a predetermined axis with respect to the parallel robot. With these embodiments, the parallel robot may drive the servo spindle to translate along the predetermined axis in the case that the joint robot stays stationary, so as to cut out the required shapes and characteristics on the mechanical part.

In some embodiments, the parallel robot is a Cartesian robot configured to drive the servo spindle to translate along three axes normal to each other with respect to the parallel robot. With these embodiments, the parallel robot may drive the servo spindle to translate along one or more of the three axes in the case that the joint robot stays stationary, so as to cut out the required shapes and characteristics on the mechanical part.

In some embodiments, the assembly further comprises the machining tool held by the servo spindle and configured to rotate under driving of the servo spindle.

In some embodiments, the machining tool comprises a drilling tool or a milling tool. With these embodiments, the mechanical part may be milled or drilled with high flexibility and stiffness in the case that the machining accuracy meets the requirements.

In a second aspect, example embodiments of the present disclosure provide an apparatus for machining a mechanical part. The apparatus comprises a joint robot comprising an end flange; and an assembly according to the first aspect of the present disclosure, wherein the parallel robot is arranged on the end flange. The apparatus according to the second aspect of the present disclosure may provide analogous advantages as the assembly according to the first aspect of the present disclosure.

In some embodiments, the joint robot is a six-axis joint robot.

In some embodiments, the apparatus further comprises a positioner arranged near to the joint robot and configured to hold the mechanical part to be machined and adjust an orientation of the mechanical part. With these embodiments, the accessibility of the joint robot can be increased by using the positioner to fix the mechanical part.

In some embodiments, the apparatus further comprises a tool changer configured to change the machining tool held by the servo spindle. With these embodiments, the machining tool held by the servo spindle may be automatically exchanged for different applications or holes in different types.

In some embodiments, the apparatus further comprises a lubricating device configured to supply a lubricant to the machining tool. With these embodiments, the lubricant supplied by the lubricating device can not only protect the machining tool from being worn, but also prevent overheating of the machining tool.

### DESCRIPTION OF DRAWINGS

Drawings described herein are provided to further explain the present disclosure and constitute a part of the present disclosure. The example embodiments of the disclosure and the explanation thereof are used to explain the present disclosure, rather than to limit the present disclosure improperly.

FIG. 1 illustrates a perspective view of an apparatus for machining a mechanical part in accordance with an embodiment of the present disclosure;

FIG. 2 illustrates a partial schematic view of the apparatus for machining the mechanical part as shown in FIG. 1;

FIG. 3 illustrates a block diagram of an apparatus for machining a mechanical part in accordance with an embodiment of the present disclosure; and

FIG. 4 illustrates a schematic view of a positioner for fixing the mechanical part in accordance with an embodiment of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to embodiments of the present disclosure, in order to break through the typical shortcomings of the machining center and the limitation of using the six-axis industrial robot independently, an assembly and an apparatus for machining a mechanical part are provided to reduce process difficulty and cost of the part machining and to increase process efficiency, flexibility and stiffness of the part machining. The above idea may be implemented in various manners, as will be described in detail in the following paragraphs.

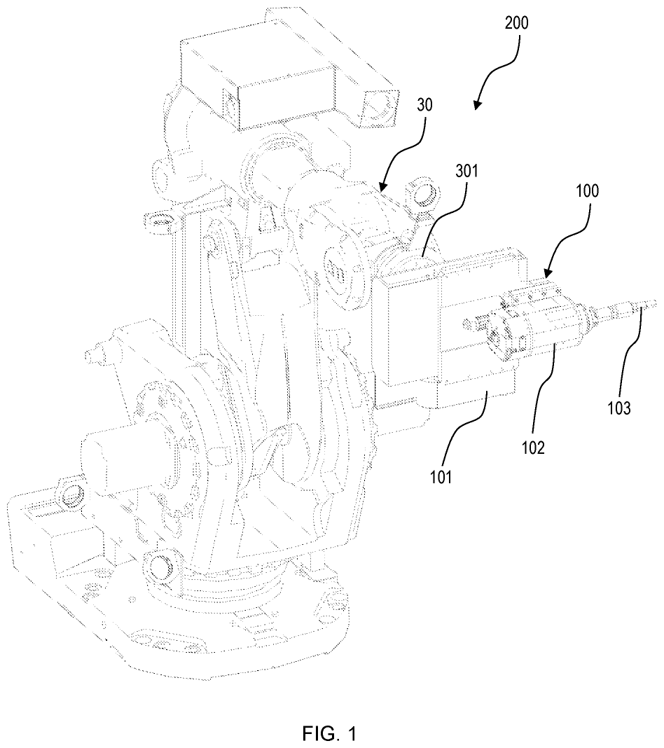

Hereinafter, the principles of the present disclosure will be described in detail with reference to FIGS. 1-4.

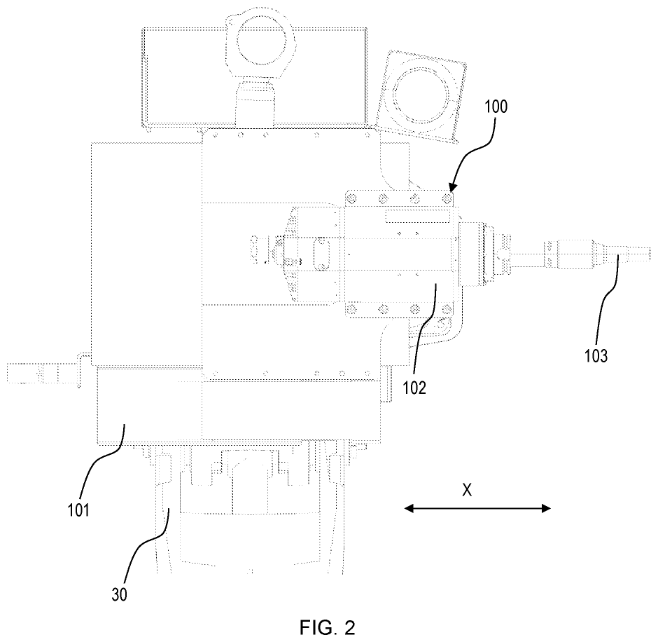

Referring to FIGS. 1 and 2 first, FIG. 1 illustrates a perspective view of an apparatus 200 for machining a mechanical part in accordance with an embodiment of the present disclosure, and FIG. 2 illustrates a partial schematic view of the apparatus 200 for machining the mechanical part as shown in FIG. 1. As shown in FIGS. 1 and 2, the apparatus 200 described herein generally includes a joint robot 30 and an assembly 100 for machining a mechanical part. The assembly 100 is mounted on an end flange 301 of the joint robot 30.

In some embodiments, the joint robot 30 is a six-axis joint robot. The six-axis joint robot may provide six degrees of freedom. The assembly 100 is mounted on the end flange 301 of six-axis joint robot. It is to be understood that the six-axis joint robot is only an example implementation of the joint robot 30, without suggesting any limitation as to the scope of the present disclosure. In other embodiments, other types of the joint robot 30 can be used.

In some embodiments, as shown in FIGS. 1 and 2, the assembly 100 includes a parallel robot 101, a servo spindle 102, and a machining tool 103. The parallel robot 101 is mounted on the end flange 301 of the joint robot 30. The parallel robot 101 includes one or more axes so as to provide translational motion along the one or more axes. The servo spindle 102 is mounted on the parallel robot 101 and may be driven by the parallel robot 101 to translate along the one or more axes with respect to the parallel robot 101, i.e., with respect to the end flange 301 of the joint robot 30. The machining tool 103 is held by the servo spindle 102 and may rotate under driving of the servo spindle 102.

According to embodiments of the present disclosure, during the machining of the mechanical part, the joint robot 30 may stay stationary for a specific machining position of the mechanical part, and only the parallel robot 101 drives the servo spindle 102 to translate along the one or more axes. This solution ideally reduces a dynamic influence from an external force, which would produce a side effect of a reactive force, on the transmission mechanism of the apparatus 200. Then, the machining tool 103 may cut out the required shapes and characteristics at the specific machining position of the mechanical part. In this way, the mechanical part may be processed with high flexibility and stiffness.

Moreover, the apparatus 200 is suitable for processing the mechanical part having complex curved surfaces or different thicknesses, such as milling or drilling, due to the use of the joint robot 30 together with the assembly 100.

Further, the apparatus 200 solves the problem regarding complexity and high cost of the customized devices in the traditional machining process of the mechanical part. Thus, it has stronger applicability, generality and economy which greatly decrease operating difficulty and cost.

In addition, the machining accuracy of the apparatus 200 may meet the requirements. For example, when the apparatus 200 is used to drill a threaded hole, the drilling accuracy of the thread hole is about −0.1 mm˜+0.1 mm.

In some embodiments, as shown in FIG. 2, the parallel robot 101 is a single-axis robot configured to drive the servo spindle 102 to translate along a predetermined axis X with respect to the parallel robot 101. With these embodiments, the parallel robot 101 may drive the servo spindle 102 to translate along the predetermined axis X in the case that the joint robot 30 stays stationary, so as to cut out the required shapes and characteristics on the mechanical part, such a circular hole or a threaded hole.

In some embodiments, the parallel robot 101 is a Cartesian robot configured to drive the servo spindle 102 to translate along three axes normal to each other with respect to the parallel robot 101. With these embodiments, the parallel robot 101 may drive the servo spindle 102 to translate along one or more of the three axes in the case that the joint robot 30 stays stationary, so as to cut out the required shapes and characteristics on the mechanical part, such as a waist-shaped hole.

It is to be understood that the single-axis robot and the Cartesian robot are only example implementations of the parallel robot 101, without suggesting any limitation as to the scope of the present disclosure. In other embodiments, the parallel robot 101 may be of other types, such as including two axes normal to each other.

According to embodiments of the present disclosure, the servo spindle 102 may drive the machining tool 103 to rotate at a high speed so as to cut out the required shapes and characteristics on the mechanical part. The servo spindle 102 may be of various conventional structures or of a structure available in the future. The scope of the present disclosure is not intended to be limited in this respect.

In an embodiment, the machining tool 103 includes a milling tool so as to carry out a milling process on the mechanical part. In another embodiment, the machining tool 103 includes a drilling tool so as to carry out a drilling process on the mechanical part. It is to be understood that the milling tool and the drilling tool are only example implementations of the machining tool 103, without suggesting any limitation as to the scope of the present disclosure. In other embodiments, the machining tool 103 may be of other types.

It is to be understood that, in some embodiments, the assembly 100 may be provided as a separate device, rather than being mounted on the joint robot 30. That is, the assembly 100 may be manufactured or sold separately, and mounted onto the end flange 301 of the joint robot 30 when the machining process needs to be carried out on the mechanical part. It is also to be understood that the machining tool 103 may be not provided on the assembly 100 when the assembly 100 is manufactured or sold, and a user may install the corresponding machining tool 103 onto the servo spindle 102 according to the actual need.

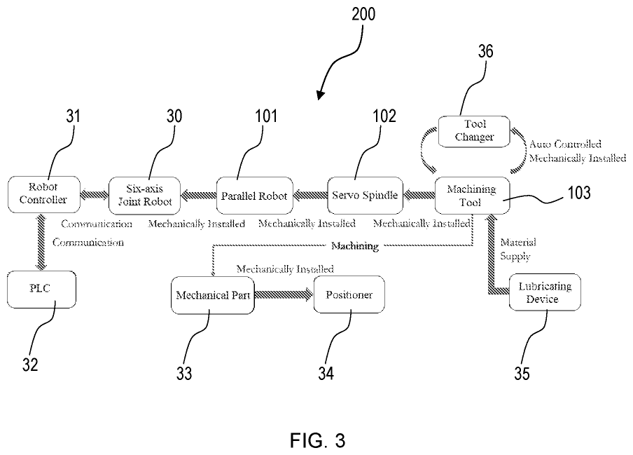

FIG. 3 illustrates a block diagram of an apparatus 200 for machining a mechanical part in accordance with an embodiment of the present disclosure. As shown in FIG. 3, in addition to the joint robot 30 and the assembly 100 as described above with reference to FIGS. 1 and 2, the apparatus 200 further includes some other devices/elements, as will be described in detail hereinafter.

In some embodiments, as shown in FIG. 3, the apparatus 200 further includes a positioner 34 configured to hold a mechanical part 33 to be machined. The positioner 34 may be arranged near to the joint robot 30 such that the machining tool 103 may reach the mechanical part 33. The positioner 34 may adjust an orientation of the mechanical part 33 during the machining process. For example, when the machining of a side of the mechanical part 33 is finished, the positioner 34 may rotate the mechanical part 33, such that the other side of the mechanical part 33 could be processed by the machining tool 103. With these embodiments, the accessibility of the joint robot 30 can be increased by using the positioner 34 to fix the mechanical part 33 and adjust the orientation of the mechanical part 33.

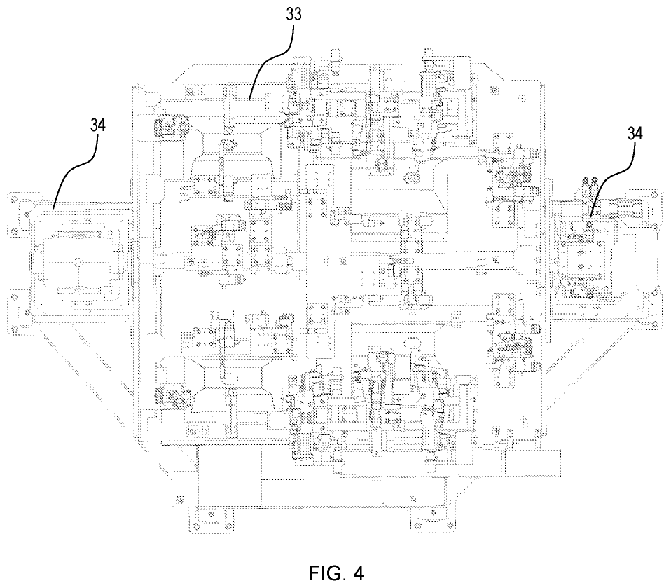

FIG. 4 illustrates a schematic view of the positioner 34 for fixing the mechanical part 33 in accordance with an embodiment of the present disclosure. As shown in FIG. 4, the positioner 34 may clamp the mechanical part 33 from both sides of the mechanical part 33. It is to be understood that in other embodiments, the positioner 34 may support the mechanical part 33 in other manners. The scope of the present disclosure is not intended to be limited in this respect.

In some embodiments, the apparatus 200 may include two joint robots 30 and corresponding assemblies 100 mounted on the end flanges 301 of the two joint robots 30. With such an arrangement, one of the joint robots 30 and the corresponding assembly 100 may be used to process a side of the mechanical part 33, and the other one of the joint robots 30 and the corresponding assembly 100 may be used to process the other side of the mechanical part 33. It is to be understood that in other embodiments, the apparatus 200 may include more than two joint robots 30 and corresponding assemblies 100. The scope of the present disclosure is not intended to be limited in this respect.

In some embodiments, as shown in FIG. 3, the apparatus 200 further includes a tool changer 36 configured to change the machining tool 103 held by the servo spindle 102. Different types of machining tools may be provided on the tool changer for use by the servo spindle 102. With these embodiments, the machining tool 103 held by the servo spindle 102 may be automatically exchanged for different applications or holes in different types.

In some embodiments, as shown in FIG. 3, the apparatus 200 further includes a lubricating device 35 configured to supply a lubricant to the machining tool 103. For example, the lubricating device 35 may include minimal quantity lubrication (MQL) device. During the machining process of the mechanical part, the lubricant may be sprayed onto the machining tool 103. With these embodiments, the lubricant supplied by the lubricating device 35 can not only protect the machining tool 103 from being worn, but also prevent overheating of the machining tool 103. Moreover, the supply of the lubricant may accelerate the machining speed of the mechanical part.

In some embodiments, as shown in FIG. 3, the apparatus 200 further includes a robot controller 31 in communication with the joint robot 30. The movement of arms of the joint robot 30 is controlled by the robot controller 31, including kinematics and dynamics control. For example, the robot controller 31 may control the moving speed, the position, and the acceleration of the arms of the joint robot 30.

In some embodiments, as shown in FIG. 3, the apparatus 200 further includes a programmable logic controller (PLC) 32 in communication with the robot controller 31. The entire machining process is controlled by the PLC 32. Specifically, the operations of the joint robot 30, the parallel robot 101, the servo spindle 102, the lubricating device 35, and other electrical or electronic device are controlled by the PLC 32.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. An assembly for machining a mechanical part, comprising:
a parallel robot adapted to be mounted onto an end flange of a joint robot and comprising one or more axes; and
a servo spindle mounted on the parallel robot and configured to drive a machining tool to rotate,
wherein the parallel robot is configured to drive the servo spindle to translate along the one or more axes with respect to the parallel robot.

2. The assembly according to claim 1, wherein the parallel robot is a single-axis robot configured to drive the servo spindle to translate along a predetermined axis with respect to the parallel robot.

3. The assembly according to claim 1, wherein the parallel robot is a Cartesian robot configured to drive the servo spindle to translate along three axes normal to each other with respect to the parallel robot.

4. The assembly according to claim 1, further comprising the machining tool held by the servo spindle and configured to rotate under driving of the servo spindle.

5. The assembly according to claim 4, wherein the machining tool comprises a drilling tool or a milling tool.

6. An apparatus for machining a mechanical part, comprising:
a joint robot comprising an end flange; and
an assembly including:
a parallel robot adapted to be mounted onto an end flange of a joint robot and comprising one or more axes; and
a servo spindle mounted on the parallel robot and configured to drive a machining tool to rotate,
wherein the parallel robot is configured to drive the servo spindle to translate along the one or more axes with respect to the parallel robot,
wherein the parallel robot is arranged on the end flange.

7. The apparatus according to claim 6, wherein the joint robot is a six-axis joint robot.

8. The apparatus according to claim 6, further comprising:
a positioner arranged near to the joint robot and configured to hold the mechanical part to be machined and adjust an orientation of the mechanical part.

9. The apparatus according to claim 6, further comprising:
a tool changer configured to change the machining tool held by the servo spindle.

10. The apparatus according to claim 6, further comprising:
a lubricating device configured to supply a lubricant to the machining tool.

11. The apparatus according to claim 6, wherein the parallel robot is a single-axis robot configured to drive the servo spindle to translate along a predetermined axis with respect to the parallel robot.

12. The apparatus according to claim 11 wherein the joint robot is a six-axis joint robot.

13. The apparatus according to claim 11, further comprising:
a positioner arranged near to the joint robot and configured to hold the mechanical part to be machined and adjust an orientation of the mechanical part.

14. The apparatus according to claim 11, further comprising:
a tool changer configured to change the machining tool held by the servo spindle.

15. The apparatus according to claim 11, further comprising:
a lubricating device configured to supply a lubricant to the machining tool.

16. The apparatus according to claim 6, wherein the parallel robot is a Cartesian robot configured to drive the servo spindle to translate along three axes normal to each other with respect to the parallel robot.

17. The apparatus according to claim 16 wherein the joint robot is a six-axis joint robot.

18. The apparatus according to claim 16, further comprising:
a positioner arranged near to the joint robot and configured to hold the mechanical part to be machined and adjust an orientation of the mechanical part.

19. The apparatus according to claim 6, wherein the assembly further includes the machining tool held by the servo spindle and configured to rotate under driving of the servo spindle.

20. The apparatus according to claim 6, wherein the machining tool comprises a drilling tool or a milling tool.
